(19) United States
(12) Patent Application Publication
(10) Pub. No.: US 2025/0241284 A1
(43) Pub. Date: Jul. 31, 2025

(54) MOSQUITO SWATTER

(71) Applicant: Lefen Industry (Shen Zhen) Co., Ltd., Shenzhen (CN)

(72) Inventors: Zhong Daikuan, Shenzhen (CN); Wang Shuming, Shenzhen (CN)

(21) Appl. No.: 18/939,642

(22) Filed: Nov. 7, 2024

(30) Foreign Application Priority Data
Jan. 31, 2024 (CN) 202420255494.7

(51) Int. Cl. A01M 3/02; H02J 7/00

(52) U.S. Cl. CPC A01M 3/022; H02J 7/0045

(57) ABSTRACT

The present application discloses a mosquito swatter, including a frame and an adhesive capturer installation bracket. The frame is provided with a hollow part, and the adhesive capturer installation bracket is arranged in the hollow part. The mosquito swatter further includes an adhesive capturer and an adhesive re-capturer. The adhesive mosquito capturer is defined with several first air holes, and the adhesive re-capturer piece is defined with several second air holes. The adhesive capturer and one side of the adhesive capturer installation bracket are detachably connected, and the adhesive re-capturer and the other side of the adhesive capturer installation bracket are detachably connected. The first air holes and the second air holes are arranged in a staggered manner.

### CROSS-REFERENCE TO RELATED APPLICATION

This application is based on and claims the priority and benefit of Chinese patent application serial no. 202420255494.7, filed on Jan. 31, 2024. The entirety of Chinese patent application serial no. 202420255494.7 is hereby incorporated by reference herein and made a part of this specification.

### TECHNICAL FIELD

The present application relates to the field of mosquito rackets, and, more particularly, to a mosquito swatter.

### BACKGROUND ART

When the human body is bitten by mosquitoes, they inject foreign substances such as antithrombin into the body through their mouthparts during biting, causing redness, swelling, itching, and pain on the skin at the bite site. Meanwhile, mosquitoes are also vectors for spreading diseases such as malaria, dengue fever, Zika virus, etc., which can impose an impact on human health.

A conventional mosquito killing method uses burning type mosquito coils or electric mosquito repelling liquid to kill mosquitoes, obtaining excellent mosquito killing effect. However, the burning type mosquito coil generates a flame, imposing a fire risk, while the electric mosquito coil liquid releases a liquid into a room through electric heating, which poses a safety hazard to the circuit and a risk of accidental ingestion by children. Therefore, using a mosquito swatter to eliminate mosquitoes is particularly popular.

Among them, China patent publication no. CN116998471A, titled “A sticky-trap mosquito swatter”, includes a handle and a frame connected to one end of the handle. The frame is provided with a support part and a hollow part. It is featured that it also includes sticky mosquito paper, with air holes defined thereon. The sticky mosquito paper is arranged on the frame and kept in contact with the support part, and the air holes are connected to the hollow part. This swatter captures mosquitoes by swinging the frame and using adhesive paper fixed to the frame. Compared to conventional electric mosquito swatters, the mosquito capturing process does not produce a burning smell, which is beneficial for promotion and application.

However, in practical applications, due to the flexible movement of mosquitoes and the presence of air holes on mosquito paper, when users swing the frame to catch mosquitoes, mosquitoes may escape along the air holes. In this case, the user has to swing the frame again to catch mosquitoes, which reduces the efficiency of mosquito capturing and, in turn, the user's experience. Therefore, further improvement is needed.

### SUMMARY

In order to improve the efficiency of mosquito swatters in capturing mosquitoes, The present application provides a mosquito swatter.

The mosquito swatter provided in The present application adopts the following technical solution:
a mosquito swatter including a frame and an adhesive capturer installation bracket. The frame is provided with a hollow part, and the adhesive capturer installation bracket is arranged in the hollow part. The mosquito swatter further includes an adhesive capturer and an adhesive re-capturer. The adhesive is defined with several first air holes, and the adhesive re-capturer is defined with several second air holes. One side of the adhesive and the adhesive capturer installation bracket is detachably connected, and the other side of the adhesive re-capturer and the adhesive capturer installation bracket is detachably connected. The first air holes and the second air holes are arranged in a staggered manner.

By adopting the above technical solution, when the user swings the frame to capture mosquitoes, there will be a situation where mosquitoes escape along the first air hole. When mosquitoes escape along the first air hole to the adhesive re-capturer, the adhesive re-capturer is provided for secondary capture of mosquitoes. Through the coordination of the adhesive capturer and the adhesive re-capturer, the probability of mosquitoes escaping along the hollow part when the user swings the frame is greatly reduced, which plays a positive guiding role in improving the efficiency of mosquito capturing.

In some embodiments, the mosquito swatter further includes a fan and a power module, wherein the fan is arranged in the hollow part, the air outlet surface of the fan faces the adhesive capturer installation bracket, the power module is arranged on the frame, and the power module is used to supply power to the fan.

By adopting the above technical solution and supplying power to the fan through the power module, the fan is in working state and generates negative pressure on the inlet surface of the fan. When the user swings the frame, the air flow velocity in the hollow part is relatively balanced with the air flow velocity on both sides of the frame, indirectly extending the time for mosquitoes to perceive changes in air flow. Moreover, through the suction force of the fan, it is easy to blow mosquitoes onto the mosquito stick, allowing the user to easily swing the frame and use the mosquito stick for mosquito sticking. Compared to electric mosquito swatters, using the mosquito stick for mosquito capturing does not produce a burnt smell, and to a certain extent reduces safety hazards during use. In addition, the fan does not abut against the adhesive capturer and the adhesive re-capturing, increasing the inlet surface of the fan. The suction volume plays a positive guiding role in enhancing the suction power of the fan.

In some embodiments, a protective net is provided on the frame, which is located at the opening of the hollow part.

By adopting the above technical solution and utilizing the protective effect of the protective net, the probability of foreign objects sticking to mosquito repellent and recaptured sticky parts is reduced. In addition, the problem of fan damage caused by user misoperation is partially solved. Mosquitoes may carry pathogenic bacteria, and the protective effect of the protective net avoids direct contact between the user's limbs and the mosquito repellent parts, thereby preventing the transfer of pathogenic bacteria to the user's limbs.

In some embodiments, the mosquito swatter further includes a black light lamp, which is arranged inside the hollow part, and the power module is configured to supply power to the black light lamp.

By adopting the above technical solution, the spectrum of the black light lamp has a strong attraction to mosquitoes. Therefore, with the assistance of the black light lamp, mosquitoes are attracted to approach the black light lamp. In addition, in environments with insufficient brightness, the black light lamp can provide illumination, making it easier for users to search for mosquitoes in such environments.

In some embodiments, the power module includes a type-C interface W1 and a battery BT1. The output terminals of the type-C interface W1 and the battery BT1 are respectively connected to the power terminal of the fan, and the power terminal of the battery BT1 is connected to the output terminal of the type-C interface.

By adopting the above technical solution, the user can choose to use wired methods, such as connecting the Type-C interface to the power cord to supply power to the mosquito swatter, or choose wireless methods, such as using batteries for power supply. Meanwhile, when using the Type-C interface for power supply, the Type-C interface can charge the battery.

In some embodiments, the power module further includes a double pole three throw switch, wherein the Type-C interface W1 and the output terminal of the battery BT1 are respectively connected to the power terminal of the fan through the double pole three throw switch, and the Type-C interface W1 and the output terminal of the battery BT1 are respectively connected to the power terminal of the black light lamp through the double pole three throw switch.

By adopting the above technical solution, the user can control the start and stop of the fan and the black light lamp through the double pole three throw switch. During use, when the current ambient brightness is sufficient, the user can turn off the black light lamp and continue the fan operation through the double pole three throw switch to achieve energy-saving goals. When the brightness of the current environment is insufficient, the user can use a double pole three throw switch to synchronize the black light lamp and fan, which can attract mosquitoes and insects to approach the black light lamp while also providing illumination.

In some embodiments, the output terminals of the type-C interface W1 and the battery BT1 are respectively connected to the common contacts in the first contact group of the double pole three throw switch. The first moving contact in the first contact group of the double pole three throw switch is connected to the common contacts in the first contact group of the double pole three throw switch. The second and third moving contacts in the first contact group of the double pole three throw switch are both connected to the common contacts in the second contact group of the switch. The first moving contact in the second contact group of the double pole three throw switch is connected to the common contacts in the second contact group of the switch. The power terminals are respectively connected to the second and third moving contacts in the second contact group of the double pole three throw switch, The power terminal of the black light lamp is connected to the third moving contact in the second contact group of the double pole three throw switch.

By adopting the above technical solution, the user can operate a double pole three throw switch to operate the mosquito swatter in three working modes: turning off both the purple light and fan, turning on both the purple light and fan, and turning off the purple light and turning on the fan.

In some embodiments, the mosquito swatter further includes a constant current and constant voltage module, and the output terminal of the type-C interface W1 is connected to the power supply terminal of the fan and the power supply terminal of the black light lamp through the constant current and constant voltage module, respectively. The constant current and constant voltage module is provided with a linear power management chip BU1.

By adopting the above technical solution and utilizing a constant current and constant voltage module, the stability of the Type-C interface power supply is ensured.

In some embodiments, the mosquito swatter further includes a battery boost module, wherein the output terminal of the battery BT1 is connected to the power supply terminal of the fan and the power supply terminal of the black light lamp through the battery boost module, and the battery boost module is equipped with a battery boost chip BU2.

By adopting the above technical solution, the battery boost module is used to increase the output voltage of the battery, ensuring that the battery can supply power to the black light lamp and fan.

In some embodiments, the capturer installation frame includes an outer frame, an installation ring, and multiple connecting rods. The installation ring and the multiple connecting rods are located inside the outer frame, and all the connecting rods are connected at one end to the outer circumference of the installation ring and at the other end to the inner wall of the outer frame. The outer circumference of the outer frame is in snap connection with the inner wall of the hollow part.

By adopting the above technical solution, the outer periphery of the outer frame is in snap connection with the inner wall of the hollow part, making the capturer installation frame detachable relative to the frame, making it easy for the user to remove the capturer installation frame to replace the mosquito capturer and rec-capturer. The structure of the adhesive capturer installation bracket enables stable connection between the adhesive capturer and the adhesive re-capturer, while air is more likely to flow in the adhesive capturer installation bracket.

In summary, The present application includes at least one beneficial technical effect as follows:
1. through the synergistic cooperation of the adhesive capturer and the adhesive re-capturer, if mosquitoes escape along the first air hole without being captured by the adhesive capturer, they can be re-captured through the adhesive re-capturer, greatly reducing the probability of mosquitoes escaping along the hollow part when the user swings the frame;
2. when the fan rotates, negative pressure is generated on the inlet surface of the fan. When the user swings the frame, the air flow velocity in the hollow part is relatively balanced with the air flow velocity on both sides of the frame, indirectly reducing the perception of airflow changes by mosquitoes. Moreover, the suction force of the fan facilitates the suction of mosquitoes onto the adhesive capturer and the adhesive re-capturer; and
3. the user can switch the mosquito swatter among three working modes: turning off both the purple light and fan, turning on both the purple light and fan, or turning off the purple light and turning on the fan by operating a double pole three throw switch, making the operation convenient.

### BRIEF DESCRIPTION OF THE DRAWINGS

FIG. 1 is a schematic diagram of an overall structure of a mosquito swatter in Embodiment 1 of the present application.

FIG. 2 is an exploded schematic diagram of an overall structure of a mosquito swatter along an axis direction shown in Embodiment 1 of the present application.

FIG. 3 is a schematic diagram of assembling relationship of an adhesive mosquito capturer, capturer installation bracket, and rec-capturer in an embodiment of the present application.

FIG. 4 is a schematic diagram of an overall structure of a mosquito swatter in Embodiment 2 of the present application.

FIG. 5 is an exploded schematic diagram of an overall structure of a mosquito swatter along an axis direction shown in Embodiment 2 of the present application.

FIG. 6 is an overall circuit schematic diagram of a mosquito swatter in Embodiment 2 of the present application.

FIG. 7 is a circuit schematic diagram of a constant current and constant voltage module in Embodiment 2 of the present application.

FIG. 8 is a circuit schematic diagram of a boost module in Embodiment 2 of the present application.

### DETAILED DESCRIPTION

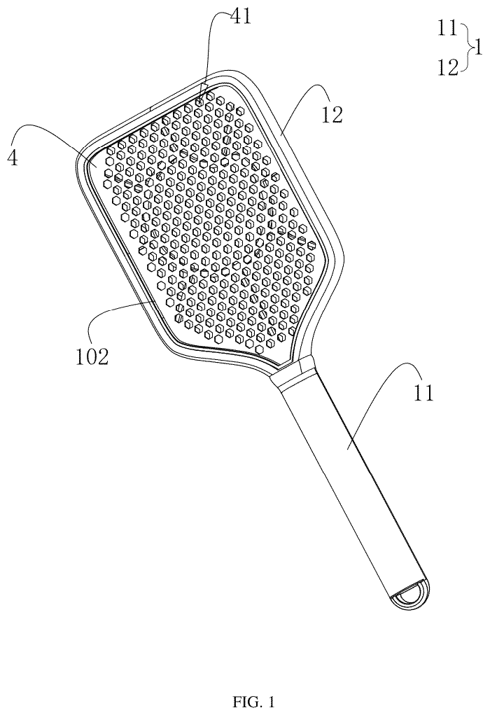

Further detailed explanation of the present application will be provided in conjunction with FIGS. 1-8.

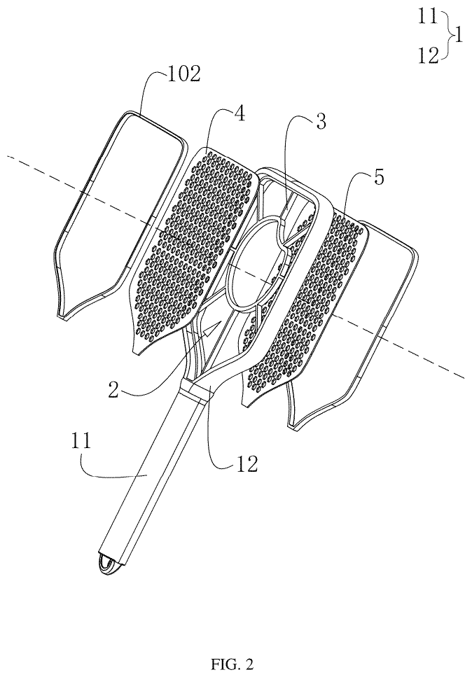

The present application discloses a mosquito swatter. Referring to FIG. 1 and FIG. 2, a mosquito swatter includes a frame 1, which is defined with a hollow part 2 for air circulation. The frame 1 includes a grip portion 11 and a mosquito capturing portion 12, which are fixedly connected. The grip portion 11 is used for a user to grip, and the hollow part 2 is defined along a center of the mosquito capturing portion 12 towards its edge. In addition, an adhesive capturer installation bracket 3 is provided in the hollow part 2.

### Embodiment 1

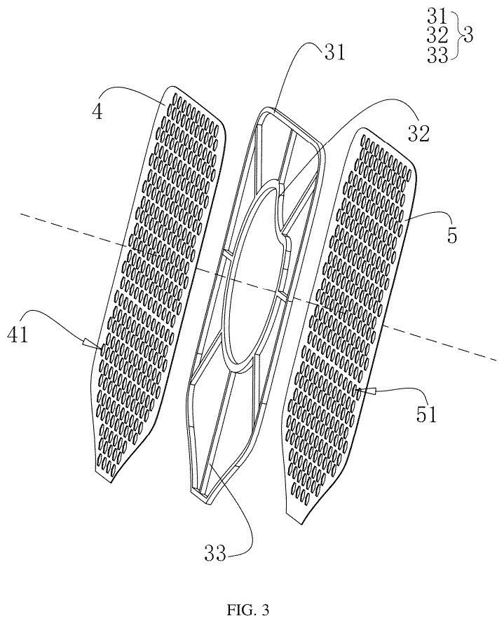

Referring to FIGS. 2 and 3, a mosquito swatter further includes an adhesive capturer 4, a adhesive re-capturer, and an adhesive capturer installation bracket 3. The adhesive capturer installation bracket 3 is arranged in the hollow part 2, and the adhesive capturer 4 is defined with several first air holes 41. The adhesive re-capturer is defined with several second air holes 51. One side of the adhesive capturer 4 and the adhesive capturer installation bracket 3 are detachably connected, and the other side of the adhesive re-capturer and the adhesive capturer installation bracket 3 are detachably connected. The first air hole 41 and the second air hole 51 are arranged in a staggered manner.

Specifically, the adhesive capturer installation bracket 3 includes an outer frame 31, an installation ring 32, and multiple connecting rods 33. The installation ring 32 and multiple connecting rods 33 are located inside the outer frame 31, and all connecting rods 33 are connected at one end to an outer circumference of the connecting ring and at the other end to the inner wall of the outer frame 31. The outer circumference of the outer frame 31 is snap connected with the inside of the hollow part 2. Since the connecting rods 33 are used to connect the installation ring 32 and the outer frame 31, the connecting ring can be stably connected to the outer frame 31, and it is also convenient for air to circulate between the adhesive capturer installation brackets 3. The specific quantity can be changed according to actual needs and thus is not limited here.

Furthermore, when the user arranges the adhesive capturer 4 and the adhesive re-capturer 5 on the two sides of the adhesive capturer installation bracket 3 respectively, two sides of the outer frame 31 and the installation ring 32 provide support for the adhesive capturer 4 and the adhesive re-capturer 5, thereby ensuring their stable installation on the adhesive paper mounting frame.

Therefore, when the outer frame 31 carries the installation ring 32 and is kept in snap connection inside of the hollow part 2, the outer frame 31 abuts against the inner wall of the hollow part 2, so that the outer frame 31 carries the installation ring 32 and is stably positioned in the hollow part 2. In addition, the user can remove the adhesive capturer installation bracket 3 along the hollow part 2, which is convenient for replacing the adhesive capturer 4 and the adhesive re-capturer 5.

Among them, the adhesive capturer 4 and the adhesive re-capturer 5 can be adhesive mosquito paper or multiple sticky wires.

The adhesive capturer 4 and the adhesive re-capturer 5 are detachably connected to the adhesive capturer installation bracket 3 through adhesive bonding. The outer shape of the adhesive capturer 4 and the outer shape of the adhesive re-capturer 5 are consistent with the outer shape of the adhesive capturer installation bracket 3. When the user sticks the adhesive capturer 4 and the adhesive re-capturer 5, the outer circumference of the adhesive capturer 4 and the adhesive re-capturer 5 is aligned with the outer circumference of the adhesive capturer installation bracket 3 to ensure that the first air hole 41 of the adhesive capturer 4 and the second air hole 51 of the adhesive re-capturer 5 are aligned in staggered way with each other after sticking.

Correspondingly, when the user places the adhesive capturer installation bracket 3 with adhesive capturer 4 and adhesive re-capturer 5 installed in the hollow part 2, in order to improve the stability of the adhesive capturer 4 and adhesive re-capturer 5 installed on the adhesive capturer installation bracket 3, positioning brackets 102 are respectively installed at the two openings of the hollow part 2 of the mosquito capturing portion 12. The external contour of the positioning bracket 102 is adapted to the shape of the hollow part 2, and the positioning bracket 102 is snap connected inside the hollow part 2, so that the adhesive capturer 4 and adhesive re-capturer 5 are stably installed on the adhesive capturer installation bracket 3, reducing the occurrence of adhesive capturer 4 and/or adhesive re-capturer falling off along the adhesive capturer installation bracket 3. In addition, the positioning bracket 102 is kept open along its geometric center towards its edge to facilitate air circulation.

In addition, due to the staggered arrangement of the first air hole 41 and the second air hole 51 when the adhesive capturer 4 and the adhesive re-capturer 5 are installed on the adhesive paper installation bracket, air can flow smoothly along the first air hole 41 and the second air hole 51. During the mosquito capturing process, if mosquitoes escape along the first air hole 41 without being adhered by the adhesive capturer 4, they can be re-captured by the adhesive re-capturer 5, greatly reducing the probability of mosquitoes escaping along the hollow part 2 when the user captures mosquitoes by holding the grip portion 11, and playing a positive guiding role in improving mosquito capturing efficiency.

The implementation principle of Embodiment 1 is as follows: there are several first air holes 41 on the adhesive capturer 4, and several second air holes 51 on the adhesive re-capturer 5. When the adhesive capturer 4 and the adhesive re-capturer 5 are respectively installed on the upper and lower surfaces of the adhesive capturer installation bracket 3, any one of the first air holes 41 and the second air hole 51 is arranged in a staggered manner. When the user holds the grip portion 11 and swings the mosquito capturing portion 12 to catch mosquitoes, mosquitoes that have not been captured by the adhesive capturer 4 escape along the first air hole 41 to the adhesive re-capturer 5. Captured by the adhesive re-capturer 5, compared to existing mosquito swatters, the probability of mosquitoes escaping along the hollow part 2 is greatly reduced.

### Embodiment 2

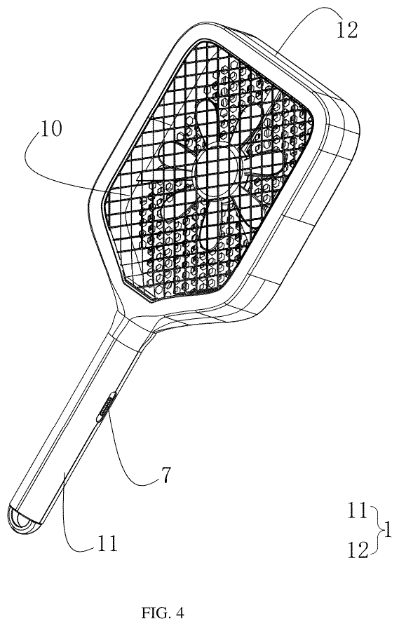

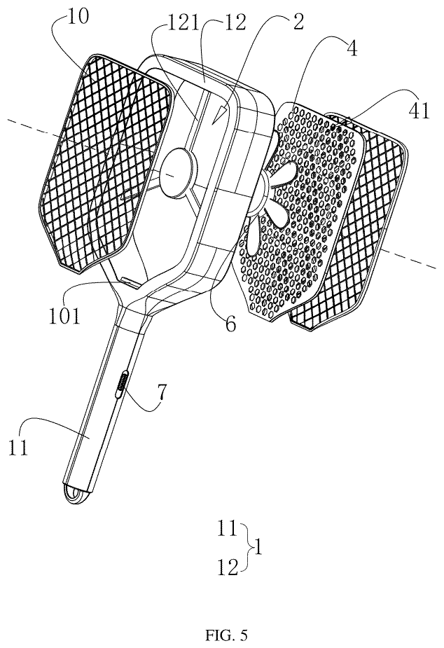

The difference from Embodiment 1 is that, referring to FIGS. 4 and 5, it further includes a fan 6 and a power module. The fan 6 is arranged in the hollow part 2, and the air outlet surface of the fan 6 faces the adhesive capturer installation bracket 3. The power module is provided on the grip portion 11, used to supply power to the fan 6.

Specifically, a carrier 121 is integrally formed in the hollow part 2, and the fan 6 is installed on the carrier 121. The fan 6 is powered by a power module, so that it can rotate stably in the hollow part 2 of the mosquito capturing portion 12, reducing the noise generated by normal operation of the fan 6.

Correspondingly, the difference from Embodiment 1 is that the adhesive capturer installation bracket 3 is snap connected inside the hollow part 2 at the outlet surface of the fan 6, and the outlet surface of the fan 6 faces the adhesive capturer installation bracket 3, without abutting against the adhesive capturer installation bracket 3, increasing the ventilation area of the outlet surface of the fan 6 and playing a positive guiding role in enhancing the suction force of the fan 6.

Therefore, when the user holds the grip portion 11 and swings the mosquito capturing portion 12, the suction provided by the fan 6 during operation is used to suck the mosquitoes along the inlet surface of the fan 6 to the outlet surface of the fan 6, blowing them onto the adhesive capturer 4 or the adhesive re-capturer 5, thereby capturing the mosquitoes. During the user's swinging process, the suction provided by the rotation of the fan 6 is used to generate negative pressure on the inlet surface of the fan 6, so that the air flow velocity in the hollow part 2 is relatively balanced with the air flow velocity on both sides of the frame 1, indirectly extending the time for mosquitoes to perceive changes in air flow. Moreover, through the suction of the fan 6, it is easy to suck mosquitoes along the inlet surface of the fan 6 to the outlet surface of the fan 6. When mosquitoes reach the air outlet of fan 6, they are blown onto the adhesive capturer 4 or the adhesive re-capturer 5 by the blowing force of fan 6, enabling the user to wave the frame 1 smoothly and use the adhesive capturer 4 to stick mosquitoes.

Referring to FIG. 5, the mosquito swatter further includes a black light lamp 101, which is arranged inside the hollow part 2. The power module is used to supply power to the black light lamp 101.

Specifically, due to the strong attraction of the spectrum of the black light lamp 101 to mosquitoes, mosquitoes are attracted towards the black light lamp 101 due to the presence of the black light lamp 101. When the black light lamp 101 attracts mosquitoes to its vicinity, the fan 6 gets into work, that is, generating negative pressure at the inlet of the fan 6 to blow the mosquitoes onto the adhesive capturer 4 or the adhesive re-capturer 5, which plays a positive guiding role in improving the mosquito capturing efficiency of the mosquito swatter.

Meanwhile, for environments with insufficient brightness, the black light lamp 101 can provide illumination, making it easier for users to find out mosquitoes and insects in such environments.

Referring to FIG. 5, a protective net 10 is installed on the frame 1, which is located at an opening of the hollow part 2.

Specifically, the external contour of the protective net 10 is adapted to the shape of the hollow part 2. In addition, the protective net 10 is provided with several through holes for air circulation along its geometric center towards its edge, and there are two pieces of protective net 10. One of the protective nets 10 is respectively snap connected in the hollow part 2 located above the adhesive capturer 4 installed on the adhesive capturer installation bracket 3, and can cover the black light lamp 101 in the hollow part 2.

In addition, another protective net 10 is snap connected in the hollow part 2 of the air inlet surface of fan 6, but not attached to the air inlet surface of fan 6. The protective net 10 located at the air inlet surface of fan 6 is fixedly connected to the mosquito capturing portion 12, covering the fan 6 in the hollow part 2, thereby reducing the probability of users accidentally touching the fan and getting hurt.

Therefore, through the protective effect of the protective net 10, the probability of foreign objects sticking to the adhesive capturer 4 and the adhesive re-capturer 5 is reduced. In addition, to a certain extent, it solves the problem of mosquitoes carrying pathogenic bacteria due to user's misoperation. Through the protective effect of the protective net 10, it avoids the direct contact between the user's limbs and the adhesive capturer 4, thereby preventing the transfer of pathogenic bacteria to the user's limbs.

When maintenance or replacement of adhesive capturer 4 and/or adhesive re-capturer 5 is required, what is need is to remove the protective net 10 in snap connected with the hollow part 2 above adhesive capturer 4, so that the adhesive capturer installation bracket 3 can be removed along the hollow part 2, which is highly convenient.

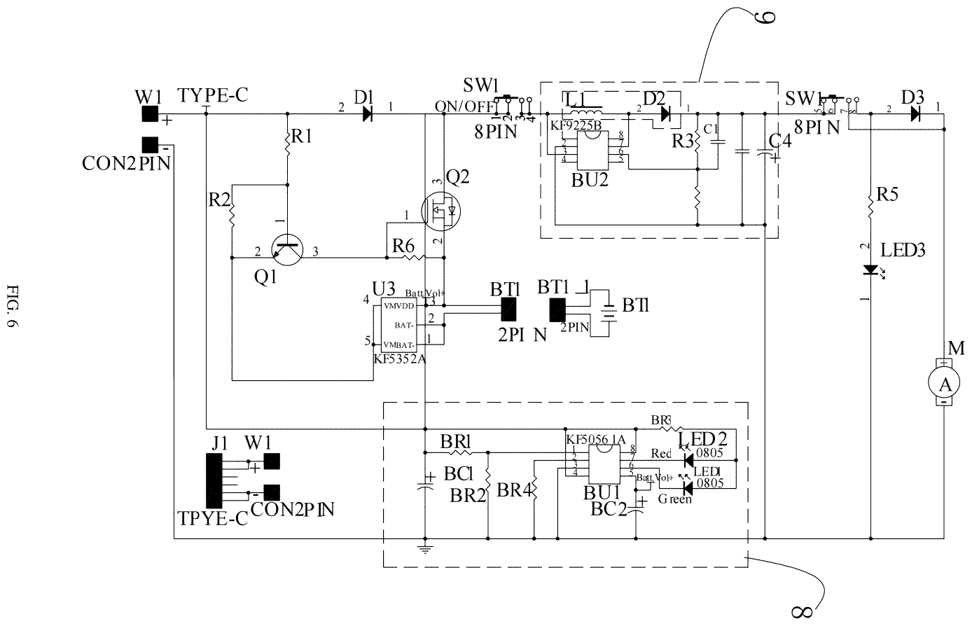

Referring to FIG. 6, the power module includes a type-C interface W1 and a battery BT1. The output terminals of the type-C interface W1 and the battery BT1 are respectively connected to the power terminal of the fan 6, and the power terminal of the battery BT1 is connected to the output terminal of the type-C interface.

Therefore, the user can use the Type-C interface W1 to connect the power cord to power the mosquito swatter. At this time, the fan 6 can also work normally and charge the battery BT1 at the same time. When the battery BT1 is fully charged, the fan 6 can be directly powered by the power supply BT1, which is highly practical.

Meanwhile, in this embodiment, the mosquito swatter as a whole can be placed on a horizontal plane along the vertical direction. When the user connects the Type-C interface W1 with a power cord to directly power the fan 6, the fan 6 can be kept in a continuous working state. Therefore, the user can place the mosquito swatter as a whole along the vertical direction on a flat surface such as a desktop. At this time, by utilizing the suction force of the fan 6 and the cooperation of the mosquito capturing adhesive capturer 4 and the adhesive re-capturer 5, mosquitoes in the current environment can be continuously captured without the need for the user to swing the mosquito capturing portion 12 by holding the grip portion 11, further enhancing the practicality of the mosquito swatter.

Referring to FIGS. 5 and 6, the power module further includes a double pole three throw switch 7. The double pole three throw switch 7 corresponds to the circuit schematic diagram of SW1. The Type-C interface W1 and the output terminal of the battery BT1 are respectively connected to the power terminal of the fan 6 through the double pole three throw switch 7. The Type-C interface W1 and the output terminal of the battery BT1 are respectively connected to the power terminal of the black light lamp 101 through the double pole three throw switch 7.

Specifically, fan 6 is M1 in the circuit schematic, and black light lamp 101 is LED3 in the circuit schematic.

Furthermore, the output terminals of Type-C interface W1 and battery BT1 are respectively connected to the common contacts in the first contact group of the double pole three throw switch 7, the first moving contact in the first contact group of the double pole three throw switch 7 is connected to the common contacts in the first contact group of the double pole three throw switch 7, the second and third moving contacts in the first contact group of the double pole three throw switch 7 are connected to the common contacts in the second contact group of the double pole three throw switch 7, the first moving contact in the second contact group of the double pole three throw switch 7 is connected to the common contacts in the second contact group of the double pole three throw switch 7, and the power supply terminals of fan 6 are respectively connected to the common contacts in the second contact group of the double pole three throw switch 7. The second and third moving contacts in the second contact group of the throw switch 7 are connected, and the power terminal of the black light lamp 101 is connected to the third moving contact in the second contact group of the double pole three throw switch 7.

The double pole three throw switch 7 is labeled as SW1 in the circuit diagram. The double pole three throw switch 7 is an 8-PIN sliding switch that changes the connection relationship between the common contact and the moving contact by sliding, where the first contact group and the second contact group change synchronously. In the circuit schematic, PIN1 of SW1 is the common contact in the first contact group, PIN2 of SW1 is the first moving contact in the first contact group, PIN3 of SW1 is the second moving contact in the first contact group, PIN4 of SW1 is the third moving contact in the first contact group, PIN5 of SW1 is the common contact in the second contact group, PIN6 of SW1 is the first moving contact in the second contact group, PIN7 of SW1 is the second moving contact in the second contact group, and PIN8 of SW1 is the third moving contact in the second contact group.

The three working modes of the double pole three throw switch 7 will be explained in connection with Table 1.

TABLE 1

| | Fan | Black light lamp |
|---|---|---|
| I | ON | OFF |
| II | ON | ON |
| OFF | OFF | OFF |

Thus, the user can switch the mosquito swatter between the three working states shown in Table 1 through the double pole three throw switch 7, making the operation convenient.

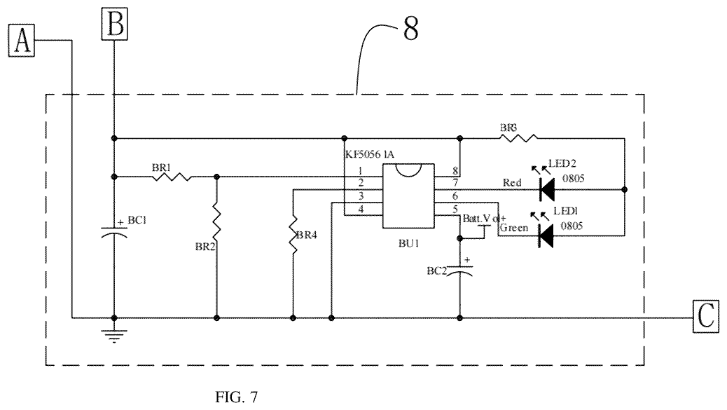

Referring to FIGS. 6 and 7, the mosquito swatter also includes a constant current and constant voltage module 8. The output terminal of Type-C interface W1 is connected to the power terminal of fan 6 and the power terminal of black light lamp 101 through the constant current and constant voltage module 8. The constant current and constant voltage module 8 is equipped with a linear power management chip BU1.

Specifically, the model of the power management chip BU1 is arranged to KF50561A or other power management chips, which improves the stability of the battery BT1 during charging and to some extent solves the probability of damage to the battery BT1 caused by unstable voltage. When the Type-C interface W1 is connected to an external power source, the seventh pin of the power management chip BU1 is turned on, and the diode LED1 is turned on, which can indicate to the user that the current battery is in a charging state.

In addition, when the battery BT1 is fully charged, the sixth pin of the power management chip BU1 is turned on, and the diode LED2 is turned on. The diode LED1 connected to the seventh pin of the power management chip BU1 is turned off to indicate to the user that the current battery BT1 is in a fully charged state.

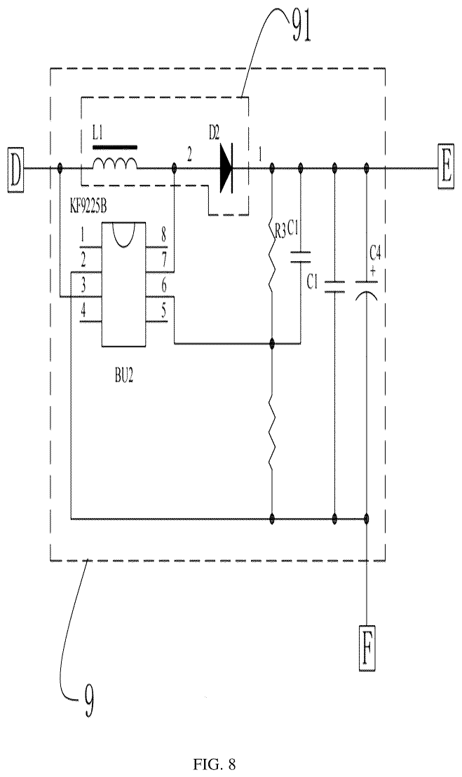

Referring to FIGS. 6 and 8, the mosquito swatter also includes a battery boost module 9. The output terminal of the battery BT1 is connected to the power terminals of the fan 6 and the black light lamp 101 through the battery boost module 9. The battery boost module 9 is equipped with a battery boost chip BU2.

Specifically, the battery boost chip BU2 is set as a KF9225B or other battery boost chip. The battery boost module 9 includes a spike suppression circuit 91, which is set as an inductor L1 and a voltage regulator diode D2. The input terminal of inductor L1 is connected to the PIN4 pin of the double pole three throw switch SW1, the output terminal of inductor L1 is connected to the positive terminal of the voltage regulator diode D2, and the negative terminal of the voltage regulator diode D2 is connected to the PIN5 pin of the double pole three throw switch SW1. The input and output terminals of inductor L1 are respectively connected to the third and seventh pins of the battery boost chip BU2.

Therefore, when the first contact group of the double pole three throw switch SW1 is turned on, the current flows through the battery boost chip BU2 along the double pole three throw switch SW1, and through the boost of the battery boost chip, the output voltage is sufficient for the normal operation of the fan 6 and the black light lamp 101.

In addition, by suppressing the peak signal in the current through inductor L1 and diode D2, the problem of high peak voltage causing damage to electronic components in the circuit or affecting the normal operation of fan 6 and black light lamp 101 can be solved to a certain extent.

The implementation principle of Embodiment 2 is: through the synergistic cooperation of the suction force of the fan 6 and the adhesive capturer installation bracket 3 attached with the adhesive capturer 4 and the adhesive re-capturer 5, when mosquitoes are in the hollow part 2, they are captured by the adhesive capturer 4. In addition, mosquitoes that have not been captured by the adhesive capturer 4 are blown by the fan 6 to reach the adhesive re-capturer 5 along the first air hole 41, and are captured by the adhesive re-capturer 5, reducing the probability of mosquito escape and thus improving the mosquito capturing efficiency of the mosquito swatter. Compared to electric mosquito swatters, this mosquito swatter does not produce a burnt smell during the mosquito capturing process, and there is no power grid inside, so even if the user accidentally touches it, it will not be affected by the touch inductance, thereby improving the user's experience.

### LISTING OF REFERENCE SIGNS

1. Frame
11. Grip portion
12. Mosquito capturing department
121. Carrier
2. Hollow part
3. Adhesive capturer installation bracket
31. Outer frame
32. Installation ring
33. Connecting rod
4. Adhesive capturer
41. First air hole
5. Adhesive re-capturer
51. Second air hole
6. Fan
7. Double pole three throw switch
8. Constant current and constant voltage module
9. Boost module
91. Spike suppression circuit
10. Protective net
101. Black light lamp
102. Positioning bracket

What is claimed is:

1. A mosquito swatter, comprising a frame and an adhesive capturer installation bracket, wherein a hollow part is defined on the frame, the adhesive capturer installation bracket is arranged in the hollow part, the mosquito swatter further comprises an adhesive capturer and an adhesive re-capturer, the adhesive capturer is defined with a plurality of first air holes, the adhesive re-capturer is defined with a plurality of second air holes, the adhesive capturer is detachably connected to a first side of the adhesive capturer installation bracket, the adhesive re-capturer is detachably connected to a second side of the adhesive capturer installation bracket, and the plurality of first air holes and the plurality of second air holes are arranged in staggered manner.

2. The mosquito swatter according to claim 1, further comprising a fan and a power module, wherein the fan is arranged in the hollow part, an air outlet surface of the fan faces the adhesive capturer installation bracket, the power module is arranged on the frame, and the power module is configured to supply power to the fan.

3. The mosquito swatter according to claim 2, wherein a protective net is provided on the frame, and the protective net is located at an opening of the hollow part.

4. The mosquito swatter according to claim 2, wherein the mosquito swatter further comprises a black light lamp arranged inside the hollow part, and the power module is used to supply power to the black light lamp.

5. The mosquito swatter according to claim 4, wherein the power module comprises a type-C interface and a battery, an output terminal of the type-C interface and the battery are respectively connected to power terminals of the fan, and a power terminal of the battery is connected to the output terminal of the type-C interface.

6. The mosquito swatter according to claim 5, wherein the power module further comprises a double pole three throw switch, the type-C interface and an output terminal of the battery are respectively connected to the power terminals of the fan through the double pole three throw switch, and the type-C interface and the output terminal of the battery are respectively connected to a power terminal of the black light lamp through the double pole three throw switch.

7. The mosquito swatter according to claim 6, wherein the output terminal of the type-C interface and the output terminal of the battery are respectively connected to a common contact in a first contact group of the double pole three throw switch, a first moving contact in the first contact group of the double pole three throw switch is connected to the common contact in the first contact group of the double pole three throw switch, a second moving contact and a third moving contact in the first contact group of the double pole three throw switch are both connected to a common contact in a second contact group of the double pole three throw switch, a first moving contact in the second contact group is connected to the common contact in the second contact group of the double pole three throw switch, the power terminals of the fan are respectively connected to the second moving contact and the third moving contact in the second contact group of the double pole three throw switch, and the power terminal of the black light lamp is connected to the third moving contact in the second contact group of the double pole three throw switch.

8. The mosquito swatter according to claim 7, wherein the mosquito swatter further comprises a constant current and constant voltage module, and the output terminal of the type-C interface is connected to the power terminals of the fan and the power terminal of the black light lamp through the constant current and constant voltage module, respectively, and the constant current and constant voltage module is provided with a linear power management chip.

9. The mosquito swatter according to claim 7, wherein the mosquito swatter further comprises a battery boost module, the output terminal of the battery is connected to the power terminals of the fan and the power terminal of the black light lamp through the battery boost module, and the battery boost module is provided with a battery boost chip.

10. The mosquito swatter according to claim 1, wherein the adhesive capturer installation bracket comprises an outer frame, an installation ring, and multiple connecting rods, the installation ring and the multiple connecting rods are all located inside the outer frame, all of the multiple connecting rods are connected at one end to an outer circumference of the installation ring and at a second end to an inner wall of the outer frame, and an outer circumference of the outer frame is in snap connection with an inner wall of the hollow part.
